(19) United States
(12) Patent Application Publication
(10) Pub. No.: US 2004/0262577 A1
(43) Pub. Date: Dec. 30, 2004

(54) Phosphor, producing method thereof, and electroluminescence device containing the same

(75) Inventors: Shigeharu Urabe, Mimami-ashigara-shi (JP); Yoshitaka Kitamura, Mimami-ashigara-shi (JP); Satoshi Aiba, Mimami-ashigara-shi (JP)

Correspondence Address: BURNS DOANE SWECKER & MATHIS L L P, POST OFFICE BOX 1404, ALEXANDRIA, VA, 22313-1404, US

(73) Assignee: Fuji Photo Film Co., Ltd., Minami-ashigara-shi (JP)

(21) Appl. No.: 10/875,714

(22) Filed: Jun. 25, 2004

(30) Foreign Application Priority Data
Jun. 26, 2003 (JP) 2003-183462

(51) Int. Cl. H01J 29/10

(52) U.S. Cl. 252/301.6 S

(57) ABSTRACT

An electroluminescence phosphor, containing zinc sulfide particles that have an average particle size of 20 μm or less, of which a distribution of particle size is a monodispersion, and which have a multi-twin crystal structure therein.

### FIELD OF THE INVENTION

The present invention relates to an electroluminescence (EL) phosphor containing zinc sulfide, as the host material, and an activator and/or a co-activator, which is to be the center of luminescence. Specifically, the present invention relates to an electroluminescence phosphor having high luminance and long life.

### BACKGROUND OF THE INVENTION

EL phosphor devices are of the voltage excitation-type phosphor device. As the EL phosphor devices, are known a thin-film-type EL phosphor device and a dispersion-type EL phosphor device, each of which is obtained by interposing a phosphor between electrodes, to form a luminous device. As to the general form of the dispersion-type EL phosphor device, it has a structure in which a material obtained by dispersing a phosphor powder in a binder having high permittivity is sandwiched between two electrodes, at least one of which is transparent, and the resulting device emits light with application of an alternating current field between these two electrodes. A luminous device produced using the EL phosphor powder has many advantages; for example, it can be as thin as several millimeters or less, and it is a plane light-emitting device with high luminous efficacy and no heat generation. For this, such a luminous device is expected to have such use applications as for road signs, illuminations for various interiors and exteriors, light sources for flat panel displays, such as liquid crystal displays, and illumination light sources for large-area advertising.

As the EL phosphor powder, powdery phosphor containing zinc sulfide as the host material, an activator, such as copper (metal ion as the center of luminescence), and a co-activator, such as chlorine, are widely known. However, luminous devices produced using this phosphor powder have the drawbacks of lower emission luminance and shorter emission life compared with luminous devices based on other principles. As such, various attempts have been made to improve these luminous devices. JP-A-8-183954 (“JP-A” means unexamined published Japanese patent application), pages 3 to 4 and FIG. 1 discloses conventional zinc sulfide phosphor particles having plane-like laminate plane defects (twin plane) in the entire particle, uniformly at high density, wherein the average plane interval between these laminate plane defects is 0.2 to 10 nm, as the structure of phosphor particles that bring about highly luminous emission. There is a description in this publication that, in this particle, copper ions, as an activator, are localized in the laminate plane defects of the zinc sulfide host crystal, and form a conductive layer, which allows electrons and holes to be released highly efficiently when voltage is applied, whereby high emission luminance can be obtained.

In the meantime, using a monocrystal of zinc sulfide, detailed studies were made as to the relation between the luminescent mechanism and particle structure, and the following findings were obtained as to, particularly, the relation between the direction of an applied field and the structure of a phosphor particle. Specifically, it was shown that, when the direction of the applied field was parallel to the (111) plane of zinc sulfide phosphor particle, maximum emission luminance was obtained, and light was emitted along a dislocation line existing on the (111) plane. These findings hinted that, when zinc sulfide particles are used as an EL luminous material, it is important for the EL luminous device to have a twin plane and/or a plane defect present on the particles.

In the case of synthesizing phosphor particles in a dispersion-type inorganic EL device, zinc sulfide particles as raw material are subjected to a first sintering (baking), at a temperature of as very high as 1300° C. to 1000° C., in combination with an inorganic salt, called a flux, to grow the particles, and then a second sintering is performed at 500 to 1000° C., to thereby obtain zinc sulfide particles for an EL device having high luminous efficacy in a currently dominant method, as shown, for example, in the above-mentioned JP-A-8-183954. There are descriptions concerning this production method in, for example, JP-A-7-62342 and JP-A-6-330035.

As to a synthesis method for zinc sulfide particles for luminous material of an inorganic EL device in a liquid phase, there is a method of synthesizing nano-size particles in an aqueous system, as seen in JP-A-2002-313568, and also reports that crystals of zinc sulfide are grown to a submicron size in an aqueous system as described in “FINE PARTICLES” (Surfactant Science Series, vol. 92, edited by Sugimoto, MARCEL DEKKER INC., 2000, pp. 190-196), “Colloids and Surface A” (1998, vol. 135, pp. 207-226), and “Crystal Research Technology” (2000, vol. 35, pp. 279-289). In “FINE PARTICLES,” the obtained submicron spherical particles are aggregate particles of nano-size microcrystals. Though spherical particles having a particle size on the micron order are obtained in “Colloids and Surface A,” the particles are likewise aggregates of crystals of small-size particles and have no twin crystal structure. In “Crystal Research Technology, ” only a single twin crystal is observed in the obtained sub-micron particles. No report has shown the synthesis of such particles as disclosed in the present invention, which have a multi-twin crystal structure and are grown as crystals in a liquid phase.

### SUMMARY OF THE INVENTION

The present invention resides in an electroluminescence phosphor, which comprises zinc sulfide particles that have an average particle size of 20 μm or less, of which a distribution of particle size is a monodispersion, and which have a multi-twin crystal structure therein.

Further, the present invention resides in an electroluminescence phosphor, which comprises zinc sulfide particles that are produced in a hydrothermal system, and that have a multi-twin crystal structure and an average particle diameter of 5 nm to 20 μm.

Further, the present invention resides in a method of producing zinc sulfide particles having a multi-twin crystal structure and an average particle diameter of 5 nm to 20 μm, which method comprises conducting a hydrothermal reaction between sulfur ion and zinc ion, using water as a reaction solvent, at a temperature of 150 to 370° C. during particle growth.

Further, the present invention resides in a dispersion, which comprises the electroluminescence phosphor described above.

Further, the present invention resides in an electroluminescence phosphor device, which comprises the electroluminescence phosphor described above.

Other and further features and advantages of the invention will appear more fully from the following description, taken in connection with the accompanying drawings.

### BRIEF DESCRIPTION OF THE DRAWINGS

FIG. 1 is a TEM photograph of particles synthesized in Example 1.

FIG. 2 is a TEM photograph of particles synthesized in Example 2.

FIG. 3 is a TEM photograph of particles synthesized in Example 3.

FIG. 4 is a TEM photograph of particles synthesized in Example 4.

FIG. 5 is a TEM photograph of particles synthesized in Comparative Example 1.

FIG. 6 is a schematic view of a hydrothermal synthesis device used in Examples 5 and 6 and Comparative Example 2.

### DETAILED DESCRIPTION OF THE INVENTION

According to the present invention, there are provided the following means:

(1) An electroluminescence phosphor, comprising zinc sulfide particles that have an average particle size of 20 μm or less, of which a distribution of particle size is a monodispersion, and which have a multi-twin crystal structure therein;

(2) An electroluminescence phosphor, comprising zinc sulfide particles that are produced in a hydrothermal system, and that have a multi-twin crystal structure and an average particle diameter of 5 nm to 20 μm;

(3) The electroluminescence phosphor according to the above item (1) or (2), wherein the zinc sulfide particles contain an activator and/or a co-activator;

(4) The electroluminescence phosphor according to any one of the above items (1) to (3), wherein the zinc sulfide particles contain at least one ion selected from copper, manganese, silver, gold, and rare earth elements, as the activator;

(5) The electroluminescence phosphor according to any one of the above items (1) to (4), wherein the zinc sulfide particles contain at least one ion selected from chlorine, bromine, iodine, and aluminum, as the co-activator;

(6) The electroluminescence phosphor according to any one of the above items (1) to (5), which contains copper ion as the activator, and chlorine ion as the co-activator;

(7) The electroluminescence phosphor according to any one of the above items (1) to (6), which is powdery;

(8) A method of producing zinc sulfide particles having a multi-twin crystal structure and an average particle diameter of 5 nm to 20 μm, comprising: conducting a hydrothermal reaction between sulfur ion and zinc ion, using water as a reaction solvent, at a temperature of 150 to 370° C. during particle growth;

(9) The method of producing zinc sulfide particles according to the above item (8), which method uses a compound that has an amino group and/or a carboxyl group, and that can form a complex with zinc;

(10) The method of producing zinc sulfide particles according to the above item (8) or (9), wherein sulfur ion is reacted with zinc ion, in the presence of an activator and/or a co-activator;

(11) A dispersion, comprising the electroluminescence phosphor according to any one of the above items (1) to (7); and

(12) An electroluminescence phosphor device, comprising the electroluminescence phosphor according to any one of the above items (1) to (7).

In the sintering method, a sintering process is carried out in a high-temperature furnace, and it is, therefore, difficult to add some materials to the system from the start to the end of the sintering process. Further, it is impossible, for example, to change the distribution of concentration of an activator or co-activator inside an individual particle. On the other hand, in the case of synthesizing zinc sulfide particles in a liquid, it is possible to change the distribution of concentration of an activator or co-activator inside an individual particle, by adding a solution containing the activator or co-activator, in a controlled amount, to a reaction solution during the particle growth, thereby a particle that cannot be obtained in the sintering method can be obtained. Also, it is possible to discriminate a core-forming process from a growing process clearly when controlling the distribution of particle size, and the degree of super saturation during the particle growth can be freely controlled, enabling control of the distribution of particle size, and hence obtaining monodispersion zinc sulfide particles having a narrow size distribution.

The inventors of the present invention have studied earnestly to solve the above problem concerning the formation of aggregate crystals in the conventional powdery phosphor constituted of zinc sulfide. As a result, we have found that it is possible to obtain uniform zinc sulfide particles having a multi-twin crystal structure and a small average particle diameter, by a reaction according to a hydrothermal synthesis method, which zinc sulfide particles are not constituted of aggregates of small-size particles but are constituted of zinc sulfide particles that are preferable as a phosphor and that have a narrow distribution of particle size; and, an EL luminous device using the phosphor powder prepared from this zinc sulfide has high luminance. The present invention was completed based on these findings.

The powdery phosphor of the present invention can be prepared in a system using water as a solvent at a high temperature; namely, by a hydrothermal system, which is completely different from the method involving sintering (solid phase) that has been widely used in this field.

For example, the above-mentioned JP-A-8-183954 discloses a sintering method in which a mixed powder containing raw material zinc sulfide, a metal compound as an activator, and a metal chloride flux as a co-activator, is placed in a porcelain crucible and subjected to a first sintering at 1200° C. for 6 hours, to obtain an intermediate phosphor having an average particle diameter of 28 μm. Thereafter, physical impact is given to the particles, and then the intermediate phosphor is subjected to a second sintering, at 700° C. for 6 hours. After that, the intermediate phosphor is subjected to a surface etching treatment, using an aqueous hydrochloric acid solution, to obtain phosphor particles for EL having an average particle diameter of 21 μm. In such a sintering method, a flux, such as barium chloride, magnesium chloride, and potassium chloride, melts at high temperatures, bringing about the growth of zinc sulfide. However, the flux is contained in a small amount, so that the surface of zinc sulfide particles is merely coated, and the system is not stirred. For this, the system is not one in which particles are dispersed in a flux solution and move freely in the solution, or zinc ions and sulfur ions can diffuse freely and uniformly, but one in which the growth of particles proceeds solely according to the mechanism of aggregation.

Also, because convection of the flux solution is not caused in the crucible, a distribution of temperature is inevitably caused in the crucible. In particular, in the case of sintering industrially, it is necessary to increase the size of the crucible. In this case, a difference in temperature is caused between the part in the vicinity of the surface of the crucible, and the inside part of the crucible, and the temperature of the former part is inevitably higher. It is clearly foreseen that, in the sintering method, particles do not grow uniformly as a whole.

The method of forming zinc sulfide particles in a hydrothermal system as disclosed in the present invention solves the drawback of the above sintering method that has been used so far. In the hydrothermal system according to the present invention, particles are dispersed in a thoroughly stirred water solvent; and, zinc ions, and/or sulfur ions causing the growth of particles, are added in the form of a solution(s), in a controlled flow rate from outside of a reactor, at fixed intervals. Accordingly, in this system, particles can move freely in the water solvent; the added ions diffuse in water, to cause uniform growth of particles; and also the temperature of the solution in the reactor is uniform.

A reaction system which can be adopted to produce zinc sulfide by the hydrothermal system according to the present invention is roughly classified into the following two systems.

1. Closed System

The sum total amount of the aqueous zinc ion solution and the aqueous sulfur ion solution was added. Then, the system is closed to carry out Ostwald ripening as it is. At this time, as a method of adding the reaction ion solutions, any one of: a method of adding one solution is added in another solution; and a method of adding both solutions in a fixed amount of water, may be adopted.

At this time, it is preferable to add both an activator such as copper ion and a co-activator such as chlorine ion. The time required for the Ostwald ripening is preferably within 100 hours, more preferably within 12 hours and 10 minutes or more. The temperature at which the Ostwald ripening is carried out is generally 150 to 370° C., preferably 200 to 370° C.

2. Open System

The zinc ions and sulfur ions constituting the particles are added continuously in the form of a solution(s). At this time, both the activator and the co-activator are also preferably added continuously. The solutions, the activator and the co-activator may be added according to various patterns. For example, it is preferable that the nucleation step be separated from the growth step, and the speed of each ion solution to be added be determined, to attain each optimum degree of supersaturation. The zinc ion and sulfur ion solutions may be added at each constant flow rate or may be added intermittently, or each flow rate may be increased or decreased by stepwise or continuously. This can also be applied to the addition of the activator and the co-activator. The core formation temperature and the particle growth temperature each are preferably 150° C. to 370° C., more preferably 200° C. to 350° C. The time taken to prepare particles is preferably within 100 hours, more preferably within 12 hours and 5 minutes or more. It is preferable to insert an Ostwald ripening step between the nucleation step and the growth step, to control the size of the particle and to attain a multi-twin crystal structure. This Ostwald ripening is carried out at a temperature of preferably 150° C. to 370° C., more preferably 200° C. to 350° C. Also, the ripening time is preferably 5 minutes to 50 hours, more preferably 20 minutes to 10 hours.

It is known that zinc sulfide crystals have very poor solubility in water: a solubility of the order of 10⁻¹² mol/L at ambient temperature. This nature is very disadvantageous in growing particles in an aqueous solution by an ionic reaction. In order to solve this problem, the zinc sulfide particles are prepared at a high temperature in the present invention. The solubility of the zinc sulfide crystal in water is increased as the temperature is raised. For example, the solubility of the zinc sulfide crystal in water is increased to the order of 10⁻⁸ mol/L at 300° C. However, water is put into a supercritical state at 375° C. or higher, and therefore the solubility of ions considerably decreases. Accordingly, the temperature at which the particles are prepared (nucleation and growth of particles) in the present invention is preferably 150° C. or higher and less than 375° C., more preferably 200° C. or higher and less than 375° C.

In the present invention, it is preferable to use a compound which can form a complex with zinc, as other measures for increasing the solubility of zinc sulfide in water. An agent for forming a complex of Zn ion, those having an amino group and/or a carboxyl group are preferable. Specific examples of the agent include ethylenediaminetetraacetic acid (hereinafter referred to as EDTA), N, 2-hydroxyethylethylenediaminetriacetic acid (hereinafter referred to as EDTA-OH), diethylenetriaminepentaacetic acid, 2-aminoethylethylene glycol tetraacetic acid, 1,3-diamino- 2-hydroxypropanetetraacetic acid, nitrilotriacetic acid, 2-hydroxyethyliminodiacetic acid, iminodiacetic acid, 2-hydroxyethylglycine, ammonia, methylamine, ethylamine, propylamine, diethylamine, diethylenetriamine, triaminotriethylamine, allylamine and ethanolamine.

The amount of this complex forming agent to be used is preferably 2 to 0.01 mol, more preferably 1 to 0.05 mol, per mol of Zn ion.

Although there are various ideas for apparatuses that can be used for the method of producing zinc sulfide particles according to the present invention, it is essential that the apparatuses have a pressure proof structure because the zinc sulfide particles are prepared at high temperatures. Also, in order to keep a reactor at high temperatures, a heating unit and a controlling device that controls the heating unit are required. Further, in order to add the reaction solution under high pressure, it is essential to use a pressure proof precision pump. When zinc sulfide particles for EL are formed, impurity metal ions are very harmful, and particularly iron, nickel and cobalt must be eliminated. It is, therefore, necessary to use materials, which are reduced in the content of these metals or free of these metals, as containers, feed pipes, stirrers and other parts that are used for the preparation of particles and are in contact with the solution. As these materials meeting such a demand which must be fulfilled in the present invention, titanium, Teflon (trade name), Hastelloy (trade name) and the like are preferable. The apparatus for preparing particles according to the present invention is preferably equipped with a stirring mechanism.

As to the stirrer, JP-B-55-10545 (“JP-B” means examined Japanese patent publication) and JP-B-49-48964 serve as a reference. Also, as to other methods of preparing particles, it is preferable to grow particles by adding fine particles, prepared in advance, in a reactor to cause Ostwald ripening in the reactor. Further, in another preferred method, fine particles are prepared just before fed to a reactor, and then they are added in the reactor successively. Regarding this, for example, JP-B-7-23218 and JP-A-10-43570 may be referred to.

As to the concentration of the reaction solution in a reactor, the concentration of generated zinc sulfide is preferably 1 mM or more and 5 M or less, more preferably 5 mM or more and 3 M or less.

In the zinc sulfide particles obtained by the present invention, the number of particles having three or more twin planes per particle is generally 30% or more, preferably 50% or more, and more preferably 70% or more, based on the total number of particles. The twin plane is detected by observing the resulting zinc sulfide particle directly as it is using a transmission electron microscope (hereinafter referred to as TEM). The higher the acceleration voltage is in the observation using an electron microscope, the clearer the obtained image is and the more easily the twin plane is confirmed. The acceleration voltage is preferably 200 kV or more, and more preferably 400 kV or more. When the size of a zinc sulfide particle becomes larger, it is difficult to obtain its TEM image as it is. Therefore, as shown in Philosophical Magazine A., vol. 62, No. 4, pp. 387-394, 1990, the obtained zinc sulfide phosphor particles are ground in alcohol using an agate mortar, and then the TEM image of the particle is obtained, thereby the number of twin planes and the density thereof can be observed.

In order to make the zinc sulfide particles obtained in a hydrothermal system according to the present invention into a highly efficient phosphor/luminescence material (photoluminescence or electroluminescence) and further to control its emitting wavelength, the particles are doped with an activator and/or a co-activator. Any activator that is generally used as an activator in a phosphor, may be used as the activator which is to be the emission center. For example, various metal ions, such as copper, manganese, silver, gold and rare earth elements, are preferably used. Specifically, acetates, sulfates or the like of these elements are preferably used. These activators may be used either singly or in combinations of two or more. The wavelength (color) of the phosphorescence/fluorescence is dependent on the type of activator, and phosphorescence/fluorescence such as bluish green (copper), orange (manganese) or blue (silver) is obtained. A preferable concentration of the activator may be in a range, for example, from 0.01 to 0.1 mass % as the concentration of copper, based on the host zinc sulfide of a final product in the case of a copper activator, although it depends on the type of activator. In order to dope zinc sulfide particles with the activator, it is preferable to form a complex of a dopant and to add it during the preparation of particles or before or after the particles are prepared. At this time, the solubility of the complex of a dope is preferably close to that of the zinc sulfide particles. This doping can be practiced with reference to JP-A-2002-338961.

As to the co-activator, a halide compound solution is added to dope the zinc sulfide particles therewith. It is particularly preferable to use a chloride. Examples of the compound include aluminum nitrate; and sodium salts, magnesium salts, barium salts and ammonium salts of chlorine, bromine or iodine.

As to the amount of the co-activator, it is added in an amount of preferably 1.0 mass % or more based on the host zinc sulfide.

The zinc sulfide particles can be doped with the activator and the co-activator in the following manner: zinc sulfide particles are once prepared in a hydrothermal system and then made into a powder by drying, the activator and/or the co-activator are added to the powder and the resulting powder is sintered. The sintering temperature at this time is preferably 300 to 1200° C., and more preferably 400 to 1000° C. The sintering time is preferably 30 minutes to 10 hours, and more preferably 1 to 7 hours. A flux may be added during sintering. Examples of the flux include common salt, magnesium chloride, barium chloride and ammonium chloride.

Impact modification (a treatment for applying an impact force having an intensity within such a range that particles are not broken), which is performed to improve the luminescence property of an EL phosphor in the sintering method, can also be used in the EL phosphor particles of the present invention. It is preferable to use, as the method for applying the impact force, a method of bringing the particles into contact with each other so as to be mixed, a (ball mill) method of mixing the particles with each other together with balls made of alumina or the like, a method of accelerating the particles so as to be caused to collide with each other, a method of radiating ultrasonic waves to the particles, or some other method.

The EL phosphor particles of the present invention can each have, on the surface thereof, a non-luminous shell layer. It is preferable that this shell layer is formed into a thickness of 0.01 μm or more by use of a chemical method after the preparation of a phosphor, which will be a core. The thickness is preferably from 0.01 to 1.0 μm. The non-luminous shell layer can be made of an oxide, nitride or oxide/nitride, or a material which is formed on the host phosphor particle, has the same composition, and contains no luminous center. The non-luminous sell layer may also be formed by growing epitaxially, on the material of the host phosphor particle, a material having a different composition. As the method for forming the non-luminous shell layer, the following can also be used: a gas phase method such as a laser ablation method, a CVD method, a plasma CVD method, a sputtering method, or a method wherein resistance heating, an electron beam method or some other method is combined with flowing-oil surface evaporation; a liquid phase method such as a double decomposition method, a sol-gel method, an ultrasonic chemical method, a method based on thermal decomposition reaction of a precursor, a reversed micelle method, a method wherein any one of these methods is combined with high-temperature sintering, a hydrothermal synthesis method, a urea melting method, or a freeze-drying method; a spraying pyrolysis method; or some other method. The liquid phase method that can be used in the present invention is particularly suitable for the synthesis of the non-luminous shell layer.

The zinc sulfide phosphor doped with the activator or co-activator and obtained in this manner is washed with water, dried, washed with hydrochloric acid and a potassium cyanide solution, and dried, to obtain an EL phosphor powder. This phosphor is dispersed in an organic binder, which is then applied to form an EL luminous layer. When an electroluminescent device in which the luminous layer is disposed between a reflection insulating layer on a backside electrode and a transparent electrode is sealed with a casing film, an electroluminescent lamp (EL illumination device) is completed. When voltage is applied between the two electrodes, the phosphor in the luminous layer emits light, due to a high electric field formed between these electrodes. When the phosphor particles are placed under a high electric field, an electric field is concentrated at a conductive layer where the activator in the particles, for example, copper ions are localized, and a very high electric field is produced there. Electrons and holes are generated from this conductive layer and recombined with each other through the activator or co-activator, to emit light. It is very important that, in the EL phosphor particles, these electrons are produced highly efficiently. It is considered that copper ions which act as the activator and chlorine ions which act as the co-activator are liable to be localized on twin planes which are defects, particularly plane defects, present in the particles. The zinc sulfide particles of the present invention have a multi-twin crystal structure, and it is, therefore, considered that the localization of these activators or co-activators is easily caused, bringing about highly efficient luminescence. Further, the present invention can bring about higher luminous efficacy, because the distribution of particle size is uniform (mono-dispersible) and the dispersion of particle structure among particles is small.

The following describes, in detail, an EL luminous device (hereinafter referred to as an “EL device”) using the zinc sulfide EL phosphor particles of the present invention.

The EL device of the present invention has a structure wherein an luminous layer is sandwiched between a pair of opposite electrodes, at least one of which is transparent. It is preferable to interpose a dielectric layer between the luminous layer and at least one of the electrodes. The luminous layer may be a layer wherein the phosphor particles are dispersed in a binder. The binder may be a polymer having a relatively high dielectric constant such as a cyanoethylcellulose-based resin; polyethylene, polypropylene, a polystyrene-based resin, silicone resin, epoxy resin, vinylidene fluoride resin, or some other resin. The dielectric constant of the dielectric layer can be adjusted by incorporating, into such a resin, an appropriate amount of fine particles having a high dielectric constant, such as BaTiO₃ or SrTiO₃ particles. For the dispersion, a homogenizer, a planetary kneader, a roll kneader, an ultrasonic disperser, or some other disperser may be used. The dielectric material to be used in such a layer may be made of any material that has a high dielectric constant, a high insulating property and a high dielectric breakdown voltage. This material is selected from metal oxides and nitrides. For example, the following is used: TiO₂, BaTiO₃, SrTiO₃, PbTiO₃, KNbO₃, PbNbO₃, Ta₂O₃, BaTa₂O_{6 , LiTaO}₃, Y₂O₃, Al₂O₃, ZrO₂, AlON, or ZnS. The selected material may be formed into a homogenous layer or a film having grain structure. In the case of the homogenous dielectric film, this film may be prepared by a gas phase method such as sputtering or vacuum evaporation. In this case, the thickness of the film is generally from 0.1 to 10 μm. If necessary, various protective layers, a filter layer, a light scattering or reflecting layer, or some other layer may be given to the structure of the EL device of the present invention.

A coating solution which contains EL phosphor particles or a coating solution which contains dielectric fine particles, each of which can be used for producing the EL device, is a coating solution which comprises at least EL phosphor particles or dielectric fine particles, a binder, and a solvent wherein the binder can be dissolved. The viscosity of this EL phosphor particle-containing coating solution or dielectric fine-particle-containing coating solution is preferably from 0.1 to 5 Pa·s, particularly preferably from 0.3 to 1.0 Pa·s at ambient temperature. If the viscosity of this solution is too low, a film having thickness unevenness is easily formed. Moreover, the phosphor particles or the dielectric fine particles may separate from the solvent and sediment with the lapse of time after the dispersion. On the other hand, if the viscosity of the solution is too high, the solution is not easily applied at relatively high coating speed. The viscosity is a value measured at 16° C., which is equal to the coating temperature.

It is preferable that the luminous layer is formed by applying a coating solution for this layer continuously, with a slide coater, extrusion coater, or the like, onto a plastic support or some other support to which a transparent electrode is provided, and the formed layer has a dry film thickness of 0.5 to 30 μm. In this case, the variation coefficient of the film thickness of the luminous layer is preferably 12.5% or less, particularly preferably 5% or less.

It is preferable for each of the functional layers applied onto the support that at least the steps from the application thereof to the drying thereof are continuously carried out. Any drying step can be divided into a constant rate drying step, wherein a coated film is dried until the film is solidified, and a falling rate drying step, wherein the solvent remaining in the coated film is decreased. The ratio of the binder in each of the functional layers is high in the present invention; therefore, if the layer is rapidly dried, only the surface thereof is dried to generate a convection current inside the coated layer. Thus, the so-called Benard cell is apt to occur. Furthermore, the solvent expands abruptly so that a blister defect is apt to occur. As a result, the uniformity of the coated film is conspicuously damaged. Contrarily, if the final drying temperature is too low, the solvent remains in each of the functional layers, to affect on post-steps (including, for example, the step of laminating a moisture-proof film) in the production of an EL device. In the drying step, therefore, it is preferable that the constant rate drying step is gently carried out, and that, at a temperature sufficient for drying the solvent, the falling rate drying step is carried out. A preferable example of the method for carrying out the constant rate drying step gently is a method of dividing a drying room wherein the support is carried into plural zones and raising the drying temperature step by step after the end of the step of the application.

In the production of the EL device of the present invention, it is also preferable that the luminous layer is subjected to a calendaring treatment with a calendaring machine. The smoothness of the two main faces of the luminous layer formed through the calendaring treatment is preferably 0.5 μm or less, more preferably 0.2 μm or less. The calendaring machine is not particularly limited, and can be appropriately selected from any machines. The calendaring treatment is a treatment of passing the luminous layer, wherein phosphor particles are dispersed in a binder, between a pair of rolls at least one of which is heated to, for example, 50 to 200° C. while the layer is pressed, thereby conducting smoothening treatment. In the calendaring treatment, it is preferable that the heating temperature of the calendaring rolls is set to not lower than the softening temperature of the binder contained in the luminous layer. It is preferable that the calendaring pressure and the conveying speed are appropriately selected so as to give a necessary smoothness, considering the calendaring temperature and the application width of the EL luminous layer so as not to break the phosphor particles or extend the luminous layer beyond a necessary extent.

In the EL device of the present invention, the transparent electrode may be made of any transparent electrode material that is generally used. Examples thereof include oxides such as tin-doped tin oxide, antimony-doped tin oxide, and zinc-doped tin oxide; a multilayer structure material wherein a silver thin film is sandwiched between two high-refractive-index layers; and a π conjugated polymer such as polyaniline or polypyrrole. It is preferable to fit metal fine lines in a comb or grid form, or some other form to the transparent electrode so as to improve the electric conductance thereof. The resistivity of the transparent electrode is preferably from 0.01 to 30 Ω/□. The back electrode, which is present on the side from which no light is taken out, may be made of any material having electric conductance. The material is appropriately selected from metals such as gold, silver, platinum, copper, iron and aluminum; graphite; and others, according to the form of an EL device to be produced, the temperature of the production process, and other factors. As the back electrode, a transparent electrode such as ITO may be used as far as the electrode has electric conductance. Each of the transparent electrode and the back electrode can be formed by preparing an electroconductive material-containing coating solution wherein the above-mentioned fine particle material that has electric conductance, together with a binder, is dispersed; and then applying the coating solution with a slide coater or extrusion coater as mentioned in the above.

In the case that a compensation electrode is provided to the EL device in order to suppress the vibration of this device, the same electroconductive material as described above can be used for this electrode. For example, in the case that a compensation electrode is fitted to the outside of the transparent electrode from which light is taken out, it is preferable to use an oxide such as tin-doped tin oxide, antimony-doped tin oxide, or zinc-doped tin oxide, a multilayer structure material wherein a silver thin film is sandwiched between high refractive index layers, a π conjugated polymer such as polyaniline or polypyrrole, or some other transparent electrode material.

In the case that the compensation electrode is fitted to the outside of the back electrode, from which no light is taken out, it is allowable to use any material that has electric conductance, for example, a metal such as gold, silver, platinum, copper, iron or aluminum, or graphite. A transparent electrode material such as ITO may be used as far as this material has electric conductance. This compensation electrode is formed beyond an insulating layer on the above-mentioned transparent electrode or back electrode. The insulating layer can be formed by evaporating or applying a dispersion wherein an insulating inorganic material, polymer material, or inorganic powdery material is dispersed in a polymer material. The compensation electrode may be formed by preparing an electroconductive material-containing coating solution wherein the above-mentioned conductive fine particle material, together with a binder, is dispersed, and then applying this solution with a slide coater or extrusion coater as mentioned in the above. Furthermore, the above-mentioned insulating material, together with a binder, is dispersed to prepare an insulating material-containing coating solution, and this solution may be applied at the same time when the above-mentioned electroconductive material-containing coating solution is applied. A voltage is applied to the fitted compensation electrode from a driving power supply. By making the phase of this voltage reverse to that of the voltage applied to the luminous layer at this time, vibration generated in the luminous layer can be offset. The compensation electrode may be formed beyond an insulating layer on the outside of either one of the transparent electrode and the back electrode. In this case, the same effects can be obtained. If the two compensation electrodes are simultaneously provided and one thereof is grounded, a further vibration-suppressing effect can be favorably expected. In order to make the vibration-suppression more effective, it is preferable to adjust the dielectric constant of the luminous layer (and the dielectric layer) and that of the insulating layer inside the compensation electrode so as to be made substantially equal.

In the case that a buffer material layer is provided to the EL device as another method for suppressing the vibration of the EL device, it is preferable to use a polymer material having a high impact absorbability or a polymer material foamed by the addition of a foaming agent. Examples of the polymer material having a high impact absorbability that can be used, include natural rubber, styrene/butadiene rubber, polyisoprene rubber, polybutadiene rubber, nitrile rubber, chloroprene rubber, butyl rubber, Hypalons (trade names), silicon rubber, urethane rubber, ethylene/propylene rubber, and fluorine-containing rubber. The hardness of these polymer materials is preferably 50 or less, more preferably 30 or less, from the viewpoint of the vibration absorbability. Butyl rubber, silicon rubber, fluorine-containing rubber and the like are more preferable, since they have a low water absorption to function also as a protective film for protecting the EL device from moisture. It is also preferable to use, as the buffer material, a material obtained by foaming the above-mentioned rubber material, or a polypropylene, polystyrene or polyethylene resin by the addition of a foaming agent into the rubber material or resin. The buffer material layer made of such a buffer material can be provided to the EL device by adhering the buffer material layer to the EL device with an adhesive agent. The buffer material layer may also be formed by dissolving the buffer material into a solvent to prepare a buffer material-containing coating solution, and then applying the coating solution with a slide coater or extrusion coater as mentioned in the above. The film thickness of the buffer material layer, which is varied depending on the hardness of the polymer material, is essentially 20 μm or more, preferably 50 μm or more, in order to absorb the vibration sufficiently. If the thickness is 200 μm or more, the thickness of the EL device increases largely so that the mass and the flexibility thereof become inconvenient. The use of the combination of the compensation electrode and the buffer material layer is preferable since the vibration can be further suppressed.

It is preferable to use, as the phosphor particles in the present invention, particles having an average particle size of 0.1 to 15 μm in order to form a luminous layer having a thickness of 30 μm or less homogeneously. The filling rate of the phosphor particles in the luminous layer is not limited, and is preferably from 60 to 95% by mass, more preferably from 80 to 90% by mass. In one embodiment of the present invention, the particle sizes of the phosphor particles are set to 15 μm or less, thereby improving the uniformity of the coated film thickness of the luminous layer and also improving the smoothness of the surface of the coated layer. Furthermore, the number of particles per unit area increases largely, thereby decreasing fine unevenness in luminescence remarkably. Moreover, the decrease in the particle sizes causes an increase in the voltage to be applied to the phosphor particles. This increase, together with an increase in the electric field strength to be applied to the luminous layer on the basis of the thinning of the luminous layer, favorably causes improvement in the luminance of the EL device, and also favorably causes suppression of the vibration which may cause noises.

The dielectric particles that can be used in the present invention may be in the form of a thin film crystal layer or in the form of grains, or may be in the form of the combination thereof. A dielectric layer containing the dielectric particles may be formed on one surface side of the phosphor particle layer. Preferably, dielectric layers are formed on both surface sides of the phosphor particle layer. When the dielectric layer is formed by coating, it is preferable to use a slide coater or extrusion coater in the same manner as in the case of the luminous layer. In the case of the thin film crystal layer, this layer may be a thin film formed on a substrate by a gas phase method such as sputtering, or a sol-gel film formed using an alkoxide of Ba, Sr or the like. In the case of the grain form, it is preferable that the size thereof is sufficiently smaller than the size of the phosphor particles. Specifically, the size is preferably within the range of 1/1000 to 1/3 of the phosphor particle size.

The dispersed-type EL device of the present invention is finally worked using a sealing film, so as to exclude the effect of humidity and oxygen from external environment. The sealing film for sealing the EL device has a water vapor permeability of preferably 0.05 g/m²/day or less, more preferably 0.01 g/m²/day or less, at 40° C. and 90%RH. Further, the sealing film has an oxygen permeability of preferably 0.1 cm³/m²/day/atm or less, more preferably 0.01 cm³/m²/day/atm or less, at 40° C. and 90%RH. Such a sealing film is preferably a laminated film composed of an organic material film and an inorganic material film. The organic material film is preferably made, for example, of a polyethylene-based resin, polypropylene-based resin, polycarbonate-based resin or polyvinyl alcohol-based resin. A polyvinyl alcohol-based resin is particularly preferable. Since a polyvinyl alcohol-based resin and the like have water absorption, it is preferable to make the resins beforehand into a bone-dry state by a treatment such as vacuum heating and then use the resin in this state.

By use of a vapor deposition, sputtering, CVD or the like method, an inorganic material film is deposited on a sheet worked from the above-mentioned resin by coating or some other method. The deposited inorganic material film is preferably made of silicon oxide, silicon nitride, silicon oxide/nitride, silicon oxide/aluminum oxide, or aluminum nitride, and is particularly preferably made of silicon oxide. In order to obtain a lower water vapor permeability or oxygen permeability or prevent the inorganic material film from being cracked by bending or the like, it is preferable to repeat the formation of the organic material film and the inorganic material film, or laminate two or more laminations each having the organic material film on which the inorganic material film is deposited onto each other through an adhesive layer or adhesive layers, thereby forming a multilayer film. The film thickness of the organic material film is preferably from 5 to 300 μm, more preferably from 10 to 200 μm. The film thickness of the inorganic material film is preferably from 10 to 300 nm, more preferably from 20 to 200 nm. The film thickness of the laminated sealing film is preferably from 30 to 1000 μm, more preferably from 50 to 300 μm. For example, in order to obtain a sealing film having a water vapor permeability of 0.05 g/m²/day or less at 40° C. and 90%RH, a film thickness of 50 to 100 μm is sufficient for a laminated structure wherein the above-mentioned two laminations, which each have the organic material film and the inorganic material film, are laminated. However, it is necessary for polyethylene chloride trifluoride, which has been conventionally used as a sealing film, to have a film thickness of 200 μm or more. As the film thickness of the sealing film is smaller, the film is more preferable from the viewpoints of the light transmissivity of the film or the flexibility of the EL device to be obtained.

When the EL cell is sealed with this sealing film, the EL cell may be put between two pieces of the sealing film so as to seal the periphery thereof, or the EL cell may be put between overlap portions of the sealing film, which are obtained by folding one piece of the sealing film into a half size, and then sealed by bonding the overlapped peripheral portions. About the EL cell sealed with the sealing film, only the EL cell may be separately formed or the EL cell may be formed directly on the sealing film. The sealing step is preferably performed in a vacuum or in a dry atmosphere the dew point of which is controlled.

Even if the sealing work is performed at a high level, it is preferable that a desiccant layer is arranged around the EL cell. Preferable examples of the desiccant that can be used in the desiccant layer include alkaline earth metal oxides such as CaO, SrO and BaO, aluminum oxide, zeolite, activated carbon, silica gel, paper and resins having a high hygroscopicity. Alkaline earth metal oxides are more preferable from the viewpoint of the hygroscopicity thereof. The desiccant may be used in the state of powder. Alternately, for example, it is preferable to use the desiccant in the form of a sheet worked by coating or molding a mixture of the desiccant with a resin material, or to apply a coating solution obtained by mixing the desiccant with a resin material to the periphery of the EL device with a dispenser or the like, so as to arrange a desiccant layer. It is more preferable to cover not only the periphery of the EL cell but also the upper and lower faces of the EL cell with the desiccant. In this case, it is preferable to deposit the desiccant layer having a high transparency on the face from which light is taken out. This high-transparency desiccant layer may be made of a polyamide-series resin or the like.

The usage application of the present invention is not particularly limited. Considering the use as a light source, the luminous color thereof is preferably white. Preferable examples of the method for making the luminous color white include a method of using phosphor particles which emit white light by themselves, such as zinc sulfide phosphor particles to which copper and manganese are added, and the particles being cooled slowly after being sintered; a method of mixing plural phosphors which emit light rays in the three primary colors or emit light rays in complementary colors (a combination of blue, green and red colors, a combination of bluish green and orange, and the like); and a method of emitting light having a short wavelength, such as blue light, and using a fluorescent pigment or a fluorescent dye to subject a part of the emitted light to wavelength-conversion into green or red light, thereby making the emitted light white, as described in JP-A-7-166161, JP-A-9-45511 or JP-A-2002-62530. About the CIE chromaticity coordinates (x, y) of the emitted light, it is preferable that the x value is from 0.30 to 0.43 and the y value is from 0.27 to 0.41.

It was confirmed by observation that in zinc sulfide particles as a phosphor or light-emitting material, plane defects, i.e. twin planes are present at high density, and discussions have been made as to the importance of these defects. The particulars concerned are disclosed in (i) Philosophical Magazine A, 1990, vol. 62, No. 4, pp. 387-394, and (ii) Philosophical Magazine B, 2001, vol. 81, No. 3, pp. 279-297.

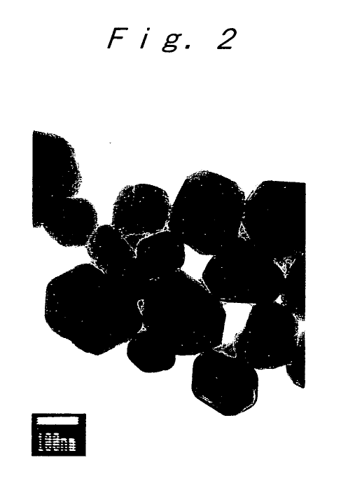

In the above documents, a plurality of parallel twin planes which are present inside of zinc sulfide phosphor particles at a very high density are clearly indicated on TEM photographs. Zinc sulfide crystals embraces two types of crystals including cubic crystal (zincblend) and hexagonal crystal (wurtzite), and twin planes are formed as a result of intermingling of these zincblend and wurtzite. This fact is illustrated in FIGS. 2, 3, 7, 9 and 10 in the above document (i). Further, the photographs showing the light-emitting state of an individual particle, as shown in FIG. 7 of the document (ii), present an important fact. Specifically, zinc sulfide particles for an EL, which are prepared by a sintering method, have the characteristics that the distribution of particle size is wide and the dispersion of luminous efficacy among particles is very large. It is observed that, particularly, particles having a small particle size make little contribution to luminance, and it is also found that there are particles having high luminance and low luminance among particles having a large size.

It is important to fulfill the following conditions, to prepare zinc sulfide particles having higher EL efficacy.

1. All or almost all particles (50% or more in the number of particles) have multi-twin crystal structures uniformly.

2. The distribution of particle size is narrow.

The sintering method which has been used hitherto, cannot attain the above conditions, as mentioned in the above. A group of highly uniform zinc sulfide particles can be obtained and higher EL luminous property is achieved, by the hydrothermal method according to the present invention.

In the meantime, the uniformity of particles, particularly the distribution of particle size is the most important factor to form a highly efficient EL luminous device. When a certain electric field is applied to this device, a higher electric field is applied to a phosphor layer, namely phosphor particles and EL luminescence can be caused more efficiently, as the thickness of the phosphor layer is thinner. However, when high voltage is applied to the device, higher voltage is applied to a thinner part of the phosphor layer, to cause short circuits at there, resulting in breakdown of the device. It is usually observed that because the distribution of phosphor particles is large, large particles extend to a neighboring layer. In this state, it is impossible to make the phosphor layer thin. Specifically, it is of importance that the boundary between the phosphor layer and a dielectric layer adjacent to the phosphor layer is strictly kept as a smooth plane. If the phosphor particles of the present invention which particles have a narrow distribution of particle size are used in place of conventionally used particles which have an average particle size of 20 to 30 μm and a very wide distribution of particle size, the state as mentioned in the above and the events resulting from this can be avoided. Also, if the average particle size is made smaller in this case, a thinner phosphor layer can be formed. As a consequence, the distribution of particle size and the average particle size of the phosphor particles of the present invention, are very important factors when an EL device having high luminous efficacy is produced.

The zinc sulfide particles of the present invention are a group of zinc sulfide particles for an EL, which have a narrow distribution of size and have a smaller average particle size as compared to the conventional particles, and the production of which have been made possible using a hydrothermal system. In the present invention, the term “group of particles” means a group of 100 or more particles, and the distribution of particle size is expressed by a coefficient of variation (COV) which is obtained by the measurement on 100 or more particles.

COV=(Standard deviation of size/Average particle size)×100

The zinc sulfide phosphor particles of the present invention is a monodispersion, and a coefficient of variation thereof is preferably as small as possible but the coefficient of variation is generally 35% or less, preferably 30% or less. The average particle size of the phosphor particles of the present invention is 20 μm or less, preferably 10 μm or less, and more preferably 5 μm or less. The lower limit of the average particle size is not particular limited, but it is preferably 5 nm or more and more preferably 10 nm or more. The size of an individual particle is expressed by a diameter of a sphere whose volume is identical to the particle volume. As to the particle size, it may be measured from a photograph taken for each particle, and the distribution of particle size may be measured optically or figured out from the sedimentation speed of the particles. Particularly, high luminance can be obtained from the zinc sulfide nanoparticles of the present invention which particles have high mono-dispersibility and a multi-twin crystal structure therein.

The EL phosphor of the present invention, which is comprised of a powder of zinc sulfide having a multi-twin crystal structure inside of the particle, is a monodispersion in the particle size and exhibit high luminance sufficient for use as a luminous device.

Further, the hydrothermal synthesis of zinc sulfide according to the present invention makes it possible to produce a high-quality EL phosphor, which has the above physical properties and exhibits excellent performance for use as a luminous device.

Further, the dispersion of the present invention can be used in producing an EL device excellent in luminance and the like.

Further, the EL device of the present invention is excellent in light-emitting efficiency, luminance, and luminance life.

The present invention will be described in more detail based on the following examples. Herein, the materials, amount of each material, ratio, contents of process, procedures of process, and the like, as shown in the following examples, may be optionally changed insofar as these changes are not deviated from the spirit of the present invention. Therefore, the scope of the present invention is not so construed as to be limited by the specific examples shown below.

### EXAMPLES

### Example 1

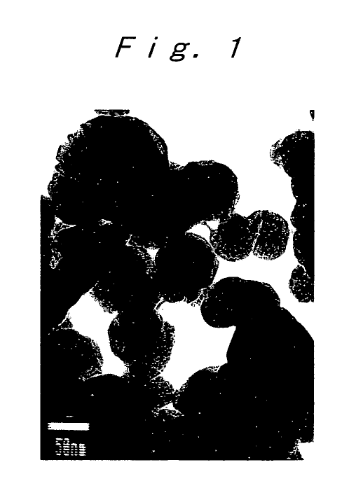

Forty grams of an aqueous 6 mM zinc disodium ethylenediaminetetraacetate solution (hereinafter abbreviated as Zn-EDTA) was added to 40 g of an aqueous 6 mM sodium sulfide solution (hereinafter abbreviated as Na₂S) at room temperature, and these were mixed. The mixture was placed in a pressure-sealed container; it was heated to 200° C. over 2 hours, and was kept at 200° C. for 1, 12, or 60 hours. After the reaction solution was returned to room temperature, powdery zinc sulfide particles were taken out from the resultant solution. The observation results of the particles with a transmission-type electron microscope (hereinafter abbreviated as TEM) demonstrated that 50% or more by number of the particles had a plurality of twin planes inside of the individual particle, and that multi-twin crystal particles A, B, and C had average particle diameters of 20, 65, and 75 nm, respectively. These particles did not form aggregates of crystals. The coefficients of variation of particle size of these multi-twin crystal particles A, B, and C were 28%, 30%, and 32%, respectively. A TEM photograph of the multi-twin crystal particles B (average particle diameter, 65 nm) is shown in FIG. 1.

When the ripening time was 60 hours, the particles further grew, to give zinc sulfide particles having an average particle diameter of 75 nm. Multi-twin crystal particles constituted of clear and many twin planes were observed. Although many particles had twin planes parallel to each other, a non-parallel twin crystal structure was also observed.

In the transmission photograph of the zinc sulfide particles taken with a transmission-type electron microscope, a particle size is found from the outside figure (outer shape), and the presence or absence of twin planes, and the density of these twin planes, can be observed from its internal structure. In FIG. 1 and FIGS. 3 to 5, the length of the white line corresponds to 50 nm.

### Example 2

Two hundreds grams of an aqueous 6 mM Zn-EDTA solution was mixed with 200 g of an aqueous 6 mM Na₂S solution at room temperature. The mixture was placed in a pressure-sealed container; and was kept at 295° C. for 5 hours. At this time, it took 2 hours to raise the temperature to 295° C. After the reaction solution was returned to room temperature, powdery zinc sulfide particles were taken out from the resultant solution. The observation results of the particles with a TEM demonstrated that 50% or more by number of the particles had multi-twin crystal structure inside of the individual particle. There are observed the case where the twin planes were parallel to each other and the case where the twin planes were not parallel to each other. The photograph taken with the TEM is shown in FIG. 2. The zinc sulfide particles did not form aggregates of crystals. The average particle diameter was 150 nm. The coefficient of variation of particle size of the zinc sulfide particles was 26%. In FIG. 2, the length of the white line corresponds to 100 nm.

### Example 3

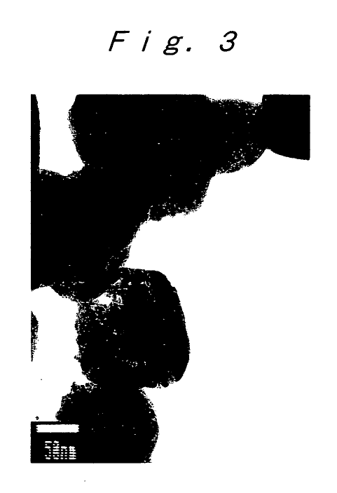

Two hundreds grams of an aqueous 30 mM Zn-EDTA solution was mixed with 200 g of an aqueous 30 mM Na₂S solution at room temperature. The mixture was placed in a pressure sealed container; it was heated to 295° C. over 2 hours, and was kept at 295° C. for 4 hours. After the reaction solution was returned to room temperature, powdery zinc sulfide particles were taken out from the resultant solution. The observation results of the particles with a TEM demonstrated that 50% or more by number of the particles had multi-twin crystal structure inside of the individual particle. The photograph taken with the TEM is shown in FIG. 3.

The preparation conditions were almost the same as those of Example 2, except that the concentration of the reaction solution was increased from 6 mM to 30 mM. Even when the concentration was increased, submicron size particles were obtained in the same manner as in Example 2, and a multi-twin crystal structure existed inside the particle.

The zinc sulfide particles did not form aggregates of crystals. The average particle diameter was 170 nm. The coefficient of variation of particle size of the zinc sulfide particles was 30%.

### Example 4

Forty grams of an aqueous 6 mM zinc hydroxyethylenediaminetriacetate solution was mixed with 40 g of an aqueous 6 mM Na₂S solution at room temperature. The mixture was placed in a pressure sealed container; it was heated to 200° C. over 1 hour and 30 minutes to 2 hours, and was kept at 200° C. for 12 hours. After the reaction solution was returned to room temperature, it was taken out from the container.

The preparation conditions in this Example were the same as those of Example 1, except that zinc hydroxyethylenediaminetriacetate was used in place of zinc disodium ethylenediaminetetraacetate in Example 1; and this was the result of the reaction for 120 hours.

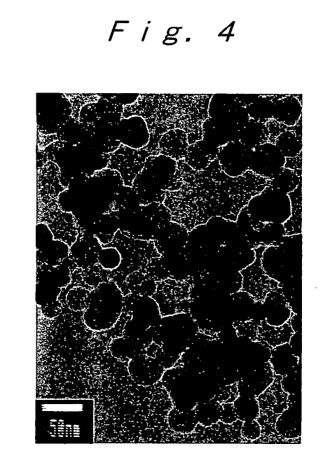

From the thus-obtained solution, powdery zinc sulfide particles were taken out. The observation results of the particles with a TEM demonstrated that a twin plane was observed inside of the individual particle, and that 50% or more by number of the particles had multi-twin crystal structure inside of the particle. The photograph taken with the TEM is shown in FIG. 4. The zinc sulfide particles did not form aggregates of crystals. The average particle diameter was 160 nm. The coefficient of variation of particle size of the zinc sulfide particles was 27%.

### Comparative Example 1

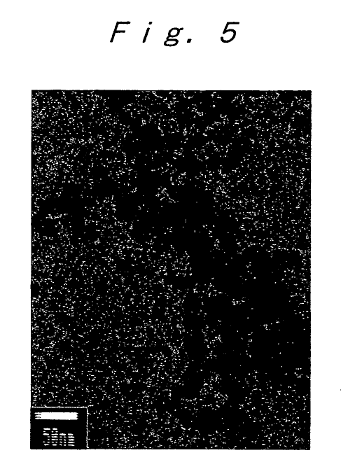

Two hundreds and fifty grams of an aqueous 6 mM Zn-EDTA solution was mixed with 250 g of an aqueous 6 mM Na₂S solution, and the mixture was kept at room temperature for 24 hours, to give particles. The thus-obtained particles were taken out from the resultant solution. The observation results of the particles with a TEM demonstrated that the particle aggregates in which small-size particles were aggregated, were obtained, as shown in FIG. 5. No multi-twin crystal structure was observed in the particles.

The size of the particles prepared at room temperature was observed to be about 20 to 30 nm on the photograph. However, these particles were found to be secondary particles in which particles having an average particle diameter of 3 nm were aggregated together, by X-ray diffraction analysis. No twin-crystal structure was present inside of such the particles.

Hereinafter, with reference to the following Examples 5 to 7 and Comparative Example 2, some specific examples of the hydrothermal synthesis of ZnS particles in an open system are described.

### Example 5

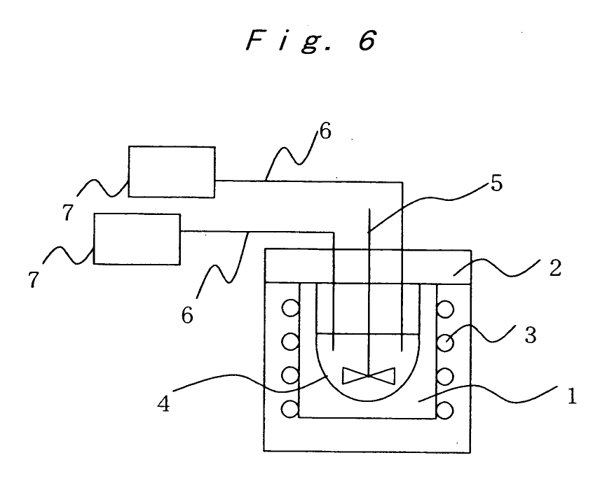

A reaction apparatus, as illustrated in FIG. 6, was used to form particles. To 150 mL of a 0.1 mol/L aqueous Na₂S solution, the temperature of which was kept at 300° C. (the pressure was naturally turned to about 9 MPa), were added, simultaneously and slowly, under stirring, 150 mL of a 0.1 mol/L aqueous Na₂S solution, and 150 mL of a mixed solution in which a 0.1 mol/L aqueous Zn(NO₃)₂ solution and a 0.05 mol/L aqueous tetrasodium ethylenediaminetetraacetate solution (hereinafter abbreviated to EDTA) were mixed. In FIG. 6, the apparatus has a pressure-resistant container 1 equipped with a heater 3 and a pressure-resistant cover 2, and it is designed to resist a pressure of 20 MPa. The pressure-resistant container has therein a sample vessel 4 (an inner volume: 800 mL) for holding a sample, and the sample liquid inside the vessel is stirred with a stirrer 5. The heater 3 is spirally wound around the pressure-resistant container 1. Each liquid is added to the sample solution through an introducing pipe 6, by means of a pressure-resistant precision pump 7 which can resist a pressure of 30 MPa. All members which contact the sample solution in the reaction apparatus are made of titanium.

The average particle size of the thus-formed particles was 2.0 μm, and the variation coefficient of particle size was 30%. The observation thereof with a TEM demonstrated that 50% or more by number of the particles had 5 or more twinning planes, on average, per particle. From the X-ray diffraction pattern thereof, it was understood that the particles were composed of zinc sulfide having a zincblende crystal structure.

### Example 6

Zinc sulfide particles were obtained in the same manner as in Example 5, except that to 75 mL of a 0.2 mol/L aqueous Na₂S solution, the temperature of which was kept at 300° C. (the pressure was naturally turned to about 9 MPa), were added, slowly and simultaneously, under stirring, 75 mL of a 0.2 mol/L aqueous Na₂S solution, and 75 mL of a mixed solution in which a 0.2 mol/L aqueous Zn(NO₃)₂ solution and a 0.1 mol/L aqueous EDTA solution were mixed. In the middle course of the addition, were added to the solution, a mixed solution in which copper sulfate and EDTA were mixed at a ratio of 1/1, and an aqueous aluminum nitrate solution, so that the concentrations of these would be 0.1 mol % and 0.1 mol %, respectively, to the resulting zinc sulfide. The average particle size of the formed zinc sulfide particles was 1.5 μm, and the variation coefficient of the particle size was 27%. The observation thereof with a TEM demonstrated that 50% or more by number of the particles had 5 or more twin planes, on average, per particle. From the X-ray diffraction pattern thereof, it was understood that the particles were composed of zinc sulfide having a zincblende crystal structure.

### Comparative Example 2

Zinc sulfide particles were obtained in the same manner as in Example 6, except that the temperature at which the particles were prepared was set to room temperature. The formed particles were spherical particles having an average particle size of 0.2 μm. However, it was proved from X-ray analysis that the particles were aggregates of fine particles having an average particle size of 10 nm. The crystal structure thereof was a zincblende structure. In these particles, no multi-twin crystal structure was observed.

### Example 7

The zinc sulfide particles of Example 6 and Comparative Example 2 were used, respectively, to produce two kinds of EL devices. The luminescence properties thereof were evaluated. The viscosity of the following coating solutions each were measured with a viscometer (VISCONIC ELD.R and VISCOMETER CONTROLLER E-200 Rotor No. 71 (each trade name), manufactured by TOKYO KEIKI INC.), at a solution temperature of 16° C., under stirring (rotation number: 20 rpm).

(Preparation of a Phosphor Coating Solution)

The zinc sulfide particles and a cyano resin (CR-S (trade name), manufactured by Shin-Etsu Chemical Co., Ltd.) as a binder were added to an organic solvent, DMF (N,N-dimethylformamide), in the ratio between these as shown below; and then the components were dispersed in the solvent with a propeller mixer (rotation number: 3,000 rpm), to prepare a coating solution (viscosity at 16° C.: 0.5 Pa·s) which contained the EL phosphor particles.

Zinc sulfide particles: 100 parts by mass

Cyano resin: 25 parts by mass

(Preparation of a Coating Solution which Contained Dielectric Fine Particles)

Barium titanate (BT-8 (trade name), manufactured by Cabbot Specialty Chemicals, the average particle size of 120 nm) as dielectric fine particles, and a cyano resin (CR-S (trade name), manufactured by Shin-Etsu Chemical Co., Ltd.) as a binder, were added to an organic solvent DMF, in the ratio between these as shown below; and then the components were dispersed in the solvent with a propeller mixer (rotation number: 3,000 rpm), to prepare a coating solution (viscosity at 25° C.: 0.5 Pa·s) which contained the dielectric fine particles.

Barium titanate: 90 parts by mass

Cyano resin: 30 parts by mass

(Production and Evaluation of an EL Device)

A slide coater was used to apply the above-mentioned EL phosphor particle-containing coating solution (of either Example 6 or Comparative Example 2), onto a polyethylene terephthalate film (thickness: 100 μm) on which an ITO transparent electrode was sputtered, as a support, such that the target thickness of the film would be 10 μm in terms of a dried coated film. After the application, the resultant support was dried at 120° C., to give a sheet-form lamination A in which an EL phosphor layer was formed on the ITO. Then, the sheet-form lamination A was again set to the applicator in which the slide coater was arranged. In the same manner as in the case of applying the above-mentioned coating solution for forming the light-emitting layer, the above-mentioned dielectric fine-particle-containing coating solution was applied, and then dried, such that the dried film thickness of the coated film would be 10 μm. Thus, a sheet-form lamination B was obtained in which the EL phosphor layer and the dielectric layer were laminated on the ITO. An aluminum foil of 30 μm thickness was laminated, as a back electrode, onto the sheet-form lamination B. Leads for supplying voltage to the transparent electrode and the back electrode were provided thereto. Thereafter, the whole was sealed with a sealing film, to obtain an EL device. An alternate current having a frequency of 1 kHz was applied, at 100 V, to each of the EL devices produced using the zinc sulfide particles of Example 6 or Comparative Example 2, respectively. The results are shown in Table 1.

TABLE 1

| | | Lifespan (time (hour) |
|---|---|---|
| | Luminance | spent until the luminance |
| Powdery phosphor | (relative value) | was reduced by half) |
| Example 6 | 230 | 210 |
| (This invention) | | |
| Comparative Example 2 | 100 | 100 |

As is apparent from the results shown in Table 1, it is understood that luminance and luminance life of the EL device of the present invention, which was produced using the zinc sulfide particles of the present invention, each were twice or more superior to those of the EL device that was produced using the zinc sulfide particles of Comparative Example 2.

Having described our invention as related to the present embodiments, it is our intention that the invention not be limited by any of the details of the description, unless otherwise specified, but rather be construed broadly within its spirit and scope as set out in the accompanying claims.

What we claim is:

1. An electroluminescence phosphor, comprising zinc sulfide particles that have an average particle size of 20 μm or less, of which a distribution of particle size is a monodispersion, and which have a multi-twin crystal structure therein.

2. The electroluminescence phosphor according to claim 1, wherein the zinc sulfide particles contain an activator and/or a co-activator.

3. The electroluminescence phosphor according to claim 2, wherein the zinc sulfide particles contain at least one ion selected from copper, manganese, silver, gold, and rare earth elements, as the activator.

4. The electroluminescence phosphor according to claim 2, wherein the zinc sulfide particles contain at least one ion selected from chlorine, bromine, iodine, and aluminum, as the co-activator.

5. The electroluminescence phosphor according to claim 2, which contains copper ion as the activator, and chlorine ion as the co-activator.

6. The electroluminescence phosphor according to claim 1, which is powdery.

7. A dispersion, comprising the electroluminescence phosphor according to claim 1.

8. An electroluminescence phosphor device, comprising the electroluminescence phosphor according to claim 1.

9. An electroluminescence phosphor, comprising zinc sulfide particles that are produced in a hydrothermal system, and that have a multi-twin crystal structure and an average particle diameter of 5 nm to 20 μm.

10. The electroluminescence phosphor according to claim 9, wherein the zinc sulfide particles contain an activator and/or a co-activator.

11. The electroluminescence phosphor according to claim 10, wherein the zinc sulfide particles contain at least one ion selected from copper, manganese, silver, gold, and rare earth elements, as the activator.

12. The electroluminescence phosphor according to claim 10, wherein the zinc sulfide particles contain at least one ion selected from chlorine, bromine, iodine, and aluminum, as the co-activator.

13. The electroluminescence phosphor according to claim 10, which contains copper ion as the activator, and chlorine ion as the co-activator.

14. The electroluminescence phosphor according to claim 9, which is powdery.

15. A dispersion, comprising the electroluminescence phosphor according to claim 9.

16. An electroluminescence phosphor device, comprising the electroluminescence phosphor according to claim 9.

17. A method of producing zinc sulfide particles having a multi-twin crystal structure and an average particle diameter of 5 nm to 20 μm, comprising: conducting a hydrothermal reaction between sulfur ion and zinc ion, using water as a reaction solvent, at a temperature of 150 to 370° C. during particle growth.

18. The method according to claim 17, which uses a compound that has an amino group and/or a carboxyl group and that can form a complex with zinc.

19. The method according to claim 17, wherein sulfur ion is reacted with zinc ion, in the presence of an activator and/or a co-activator.

20. The method according to claim 19, wherein the activator is at least one ion selected from copper, manganese, silver, gold, and rare earth elements, and the co-activator is at least one ion selected from chlorine, bromine, iodine, and aluminum.
